(19) United States
(12) Patent Application Publication
(10) Pub. No.: US 2008/0290736 A1
(43) Pub. Date: Nov. 27, 2008

(54) Power transmission device and electronic instrument

(75) Inventors: Kota Onishi, Nagoya-shi (JP); Haruhiko Sogabe, Chino (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/153,781

(22) Filed: May 23, 2008

(30) Foreign Application Priority Data
May 25, 2007 (JP) 2007-139282

(51) Int. Cl. H02J 5/00

(52) U.S. Cl. 307/107

(57) ABSTRACT

A control IC for first and second transmission drivers that drive a primary coil includes an output terminal connected to the first transmission driver on a first side, an output terminal connected to the second transmission driver on a second side, and an input terminal to which a waveform of a coil connection terminal is input through a waveform detection wiring pattern on a third side. The control IC is disposed in a center area of a board at a position shifted in a first direction with respect to a centerline. The coil connection terminal and a resonant capacitor are disposed in first and second row positions on the end of the board. The first transmission driver is disposed at a position shifted in the first direction with respect to the first side of the control IC. The second transmission driver is disposed at a position opposite to the second side of the control IC. The waveform detection wiring pattern extends from the third side of the control IC to the coil connection terminal through an area shifted in a second direction with respect to the centerline.

Japanese Patent Application No. 2007-139282 filed on May 25, 2007, is hereby incorporated by reference in its entirety.

### BACKGROUND OF THE INVENTION

The present invention relates to a power transmission device which performs non-contact power transmission, an electronic instrument, and the like.

In recent years, non-contact power transmission (contactless power transmission) that utilizes electromagnetic induction to enable power transmission without metal-to-metal contact has attracted attention. As application examples of non-contact power transmission, charging a portable telephone, a household appliance (e.g., telephone handset), and the like has been proposed.

JP-A-2006-60909 discloses non-contact power transmission. In JP-A-2006-60909, a series resonant circuit is formed using a resonant capacitor connected to the output of a power transmission driver and a primary coil so that power is supplied from a power transmission device (primary side) to a power reception device (secondary side).

A large high-frequency alternating analog current of about several hundreds of mA to 1 A flows through a power circuit (e.g., primary coil, resonant capacitor, and transmission driver) of the power transmission device, for example. On the other hand, a weak digital signal or analog signal flows through an IC that controls the power circuit and its peripheral circuit. Therefore, the power circuit of the power transmission device cannot be appropriately controlled without reducing an adverse effect due to a large analog current.

Several aspects of the invention may provide a power transmission device and an electronic instrument which can reduce an adverse effect due to a large analog current by separating a large analog current from a weak analog signal or digital signal.

### SUMMARY

According to one aspect of the invention, there is provided a power transmission device that includes a primary coil and electromagnetically couples the primary coil with a secondary coil of a power reception device to supply power to a load of the power reception device, the power transmission device comprising:

a first coil connection terminal and a second coil connection terminal respectively connected to ends of the primary coil;

a resonant capacitor that forms a series resonant circuit with the primary coil;

a first power transmission driver and a second power transmission driver that drive the primary coil from the ends of the primary coil through the first coil connection terminal and the second coil connection terminal; and

a control IC that outputs driver control signals to the first power transmission driver and the second power transmission driver,

the first coil connection terminal, the second coil connection terminal, the resonant capacitor, the first power transmission driver, the second power transmission driver, and the control IC being provided on a mounting surface of a printed circuit board,

the control IC being formed in the shape of a quadrangle that has a first side, a second side, a third side, and a fourth side, an output terminal of the driver control signal output to the first transmission driver being provided on the first side, an output terminal of the driver control signal output to the second transmission driver being provided on the second side adjacent to the first side, an input terminal that receives a signal waveform at the second coil connection terminal through a waveform detection wiring pattern being disposed on the third side opposite to the first side, and the control IC being disposed at a position shifted in a first direction with respect to a centerline that divides the printed circuit board in two and is parallel to the first side and the third side;

the first coil connection terminal and the second coil connection terminal being disposed in a first row position on an end of the printed circuit board, and, when a direction opposite to the first direction is referred to as a second direction, the second coil connection terminal being disposed at a position shifted in the second direction with respect to the centerline;

the resonant capacitor being disposed in a second row position between the first row position where the first coil connection terminal and the second coil connection terminal are disposed and a row position where the control IC is disposed;

the first power transmission driver and the second power transmission driver being disposed between the first row position and the row position where the control IC is disposed, and the first transmission driver being disposed at a position shifted in the first direction with respect to the first side of the control IC; and

the waveform detection wiring pattern extending from the third side of the control IC to the second coil connection terminal through an area of the printed circuit board shifted in the second direction with respect to the centerline.

According to another aspect of the invention, there is provided an electronic instrument comprising the above power transmission device.

### BRIEF DESCRIPTION OF THE SEVERAL VIEWS OF THE DRAWING

FIGS. 1A and 1B are views illustrative of non-contact power transmission.

FIG. 2 are views showing a configuration example of a power transmission device, a power transmission control device, a power reception device, and a power reception control device according to one embodiment of the invention.

FIGS. 3A and 3B are views illustrative of data transmission by means of frequency modulation and load modulation.

FIG. 4 is a view showing a configuration example of a power transmission control device according to one embodiment of the invention.

FIGS. 5A and 5B are views illustrative of the tan δ value of a capacitor.

FIG. 6 is a view showing a layout example of a control IC.

FIG. 7 is a view illustrative of two power transmission drivers and a series resonant circuit.

FIG. 8 is a view showing the layout of main components on a mounting surface of a printed circuit board.

FIG. 9 is a view showing wiring patterns on a mounting surface of a printed circuit board.

FIG. 10 is a view showing power supply wiring patterns on a back surface of a printed circuit board.

FIG. 11 is a view schematically showing the relationship between ground power supply patterns.

### DETAILED DESCRIPTION OF THE EMBODIMENT

According to one embodiment of the invention, there is provided a power transmission device that includes a primary coil and electromagnetically couples the primary coil with a secondary coil of a power reception device to supply power to a load of the power reception device, the power transmission device comprising:

a first coil connection terminal and a second coil connection terminal respectively connected to ends of the primary coil;

a resonant capacitor that forms a series resonant circuit with the primary coil;

a first power transmission driver and a second power transmission driver that drive the primary coil from the ends of the primary coil through the first coil connection terminal and the second coil connection terminal; and

a control IC that outputs driver control signals to the first power transmission driver and the second power transmission driver,

the first coil connection terminal, the second coil connection terminal, the resonant capacitor, the first power transmission driver, the second power transmission driver, and the control IC being provided on a mounting surface of a printed circuit board,

the control IC being formed in the shape of a quadrangle that has a first side, a second side, a third side, and a fourth side, an output terminal of the driver control signal output to the first transmission driver being provided on the first side, an output terminal of the driver control signal output to the second transmission driver being provided on the second side adjacent to the first side, an input terminal that receives a signal waveform at the second coil connection terminal through a waveform detection wiring pattern being disposed on the third side opposite to the first side, and the control IC being disposed at a position shifted in a first direction with respect to a centerline that divides the printed circuit board in two and is parallel to the first side and the third side;

the first coil connection terminal and the second coil connection terminal being disposed in a first row position on an end of the printed circuit board, and, when a direction opposite to the first direction is referred to as a second direction, the second coil connection terminal being disposed at a position shifted in the second direction with respect to the centerline;

the resonant capacitor being disposed in a second row position between the first row position where the first coil connection terminal and the second coil connection terminal are disposed and a row position where the control IC is disposed;

the first power transmission driver and the second power transmission driver being disposed between the first row position and the row position where the control IC is disposed, and the first transmission driver being disposed at a position shifted in the first direction with respect to the first side of the control IC; and

the waveform detection wiring pattern extending from the third side of the control IC to the second coil connection terminal through an area of the printed circuit board shifted in the second direction with respect to the centerline.

According to one embodiment of the invention, the primary coil, the resonant capacitor, the first transmission driver, and the second transmission driver are power circuits. the power circuits through which a high-frequency large analog alternating current flows are collectively disposed in the first and second row positions on the mounting surface of the printed circuit board. The wiring patterns for the driver control signals supplied from the control IC to the first transmission driver and the second transmission driver are collectively disposed on the printed circuit board in the first direction with respect to the centerline. Therefore, a space for forming the waveform detection wiring pattern through which a weak analog signal flows can be provided on the printed circuit board in the second direction with respect to the centerline. This makes it possible to separate a large analog current from a weak analog signal. The control IC includes a waveform detection circuit. The waveform detection circuit monitors the waveform of a signal that corresponds to the induced voltage at one end of the primary coil, and detects a change in load on the secondary side (power reception device). This enables data (load) detection, foreign object (metal) detection, detachment (removal) detection, and the like.

In the power transmission device according to this embodiment,

the resonant capacitor may include a first resonant capacitor connected to the first coil connection terminal and a second resonant capacitor connected to the second coil connection terminal;

the second power transmission driver may be disposed between the first resonant capacitor and the second resonant capacitor disposed in the second row position;

the first transmission driver may be disposed in a third row position adjacent to the second row position; and

the control IC may be disposed in a fourth row position adjacent to the third row position.

The number of resonant capacitors that form a series resonant circuit with the primary coil may be one. Note that a first resonant capacitor and a second resonant capacitor may be disposed corresponding to the ends of the primary coil. In this case, the second transmission driver may be disposed between the first resonant capacitor and the second resonant capacitor in the second row position. On the other hand, the first transmission driver may not be disposed in the second row position due to limitations to the width of the board. Therefore, the first transmission driver is disposed in the third row position. Since the first transmission driver is disposed at a position shifted in the first direction with respect to the control IC, the waveform detection wiring pattern is not adversely affected.

In the power transmission device according to this embodiment,

the waveform detection wiring pattern may include a wide pattern formed from the second coil connection terminal to a position shifted in the second direction with respect to the second coil connection terminal in the second row position, and a narrow pattern, one end of the narrow pattern being connected to the wide pattern and the other end of the narrow pattern being connected to the input terminal provided on the third side of the control IC. Even if the waveform detection wiring pattern connected to the control IC has a narrow pattern, an adverse effect due to a large analog current is reduced due to the wiring layout.

In the power transmission device according to this embodiment,

the power transmission device may include power supply patterns provided on a back surface of the printed circuit board opposite to the mounting surface,

the power supply patterns may include:

a power ground power supply pattern connected to the first power transmission driver and the second power transmission driver; and

an analog ground power supply pattern and a digital ground power supply pattern connected to power supply terminals of the control IC;

the analog ground power supply pattern may be formed in the shape of an island in a center area opposite to at least part of the control IC and the narrow pattern of the waveform detection wiring pattern, the power ground power supply pattern may be formed in a first area opposite to the first row position and the second row position, and the digital ground power supply pattern may be formed in a second area opposite to the power ground power supply pattern through the analog ground power supply pattern; and

the power ground power supply pattern and the digital ground power supply pattern may be connected in an area between the analog ground power supply pattern in the shape of an island and an edge of the printed circuit board.

It is possible to stabilize the reference potentials of the power circuit, the analog circuit, and the digital circuit due to reduced interference by separating the power ground power supply pattern, the analog ground power supply pattern, and the digital ground power supply pattern, as described above.

In the power transmission device according to this embodiment,

the power supply patterns may further include a power power supply pattern connected to the first power transmission driver and the second power transmission driver; and

the power power supply pattern may be provided from the first area to the second area while avoiding an area opposite to the narrow pattern of the waveform detection wiring pattern formed on the mounting surface. This reduces an adverse effect of the power power supply pattern on the narrow pattern of the waveform detection wiring pattern.

In the power transmission device according to this embodiment,

the power transmission device may include an oscillator that is provided on the mounting surface of the printed circuit board and is connected to a terminal provided on the second side of the control IC, the oscillator being disposed at a position opposite to a boundary area between the analog ground power supply pattern and the power ground power supply pattern provided on the back surface of the printed circuit board,

the digital ground power supply pattern may include a first protrusion pattern that protrudes from the first area to the second area in the shape of a strip so that the digital ground power supply pattern is connected to the oscillator.

Since the oscillator generates a reference frequency based on which a drive frequency of the power circuit is generated, a serious problem does not occur even if the oscillator is brought close to the power circuit. On the other hand, since it is necessary to supply a digital ground power supply potential to the oscillator, the digital ground power supply potential is supplied to the oscillator through the first protrusion pattern.

In the power transmission device according to this embodiment,

the oscillator may be provided on the mounting surface of the printed circuit board between a wiring pattern that connects the second transmission driver with a terminal provided on the second side of the control IC and the waveform detection wiring pattern.

Since the waveform detection wiring pattern is less adversely affect by the output from the oscillator as compared with the driver control signal supplied to the transmission driver, an adverse effect of the driver control signal on the waveform detection wiring pattern can be reduced.

In the power transmission device according to this embodiment,

the digital ground power supply pattern may further include a second protrusion pattern that protrudes from the first area to the second area in the shape of a strip, the second protrusion pattern being provided at a position opposite to the first protrusion pattern through the analog ground power supply pattern; and

the analog ground power supply pattern may be enclosed by the digital ground power supply pattern, the first protrusion pattern, and the second protrusion pattern.

In the power transmission device according to this embodiment,

the control IC may include a first predriver and a second predriver that generate the driver control signals supplied to the first power transmission driver and the second power transmission driver, each of the first predriver and the second predriver including complementary transistors; and

the second protrusion pattern may be set at a ground potential supplied to gates of the complementary transistors.

Since a small signal synchronized with the first transmission driver and the second transmission driver flows through the first predriver and the second predriver, an adverse effect occurs to only a small extent even if the second protrusion pattern is brought close to the power circuit. The analog ground power supply pattern can be separated from the power ground power supply pattern utilizing the first protrusion pattern and the second protrusion pattern.

In the power transmission device according to this embodiment,

the power transmission device may include a first thermistor that detects a temperature of the resonant capacitor, the first thermistor being disposed on the mounting surface of the printed circuit board between the second row position and the row position where the control IC is disposed. This enables the first thermistor that detects the temperature of the resonant capacitor disposed in the second row position to be disposed close to the resonant capacitor.

In the power transmission device according to this embodiment,

a terminal that is connected to the first thermistor may be disposed on the fourth side of the control IC; and

the first thermistor and the terminal disposed on the fourth side may be connected on the back surface of the printed circuit board through a wiring pattern provided between the analog ground power supply pattern in the shape of an island and the digital ground power supply pattern.

The first thermistor and the control IC cannot be connected on the mounting surface of the printed circuit board due to the driver control signal wiring patterns connected to the first transmission driver and the second transmission driver. Therefore, the first thermistor and the control IC are connected through a wiring pattern provided in an area between the analog ground power supply pattern in the shape of an island and the digital ground power supply pattern in which a change in potential is relatively small.

In the power transmission device according to this embodiment,

the first thermistor may be thermally coupled with the resonant capacitor through the power ground power supply pattern. The power ground power supply pattern is not connected to the first thermistor. On the other hand, the resonant capacitor and the first thermistor in the area opposite to the power ground power supply pattern can be thermally coupled through the power ground power supply pattern by disposing the first thermistor to overlap the formation area of the power ground power supply pattern.

In the power transmission device according to this embodiment,

the power transmission device may include a second thermistor that detects an ambient temperature, the second thermistor being disposed on the mounting surface of the printed circuit board at a position opposite to the fourth side of the control IC,

the second thermistor and a terminal provided on the fourth side of the control IC may be connected through a wiring pattern. The first thermistor and the second thermistor are thus disposed away from each other. Therefore, the second thermistor can measure the ambient temperature without being affected by heat generated by the resonant capacitor.

In the power transmission device according to this embodiment,

the control IC may include a temperature detection circuit that detects an abnormality in tan δ of the resonant capacitor by calculating a difference between the temperature of the resonant capacitor from the first thermistor and the ambient temperature from the second thermistor. Specifically, an abnormality in the resonant capacitor that generates heat when an abnormal current flows through the primary coil can be detected based on an abnormality in tan δ.

In the power transmission device according to this embodiment,

the control IC may include a control circuit that stops power transmission using the first power transmission driver and the second power transmission driver when an abnormality in tan δ of the resonant capacitor has been detected. This makes it possible to stop power transmission when a foreign matter such as a metal has been disposed opposite to the primary coil, whereby safety is improved.

According to another embodiment of the invention, there is provided an electronic instrument comprising the above power transmission device.

Preferred embodiments of the invention are described in detail below. Note that the embodiments described below do not in any way limit the scope of the invention defined by the claims laid out herein. Note that all elements of the embodiments described below should not necessarily be taken as essential requirements for the invention.

1. Electronic Instrument

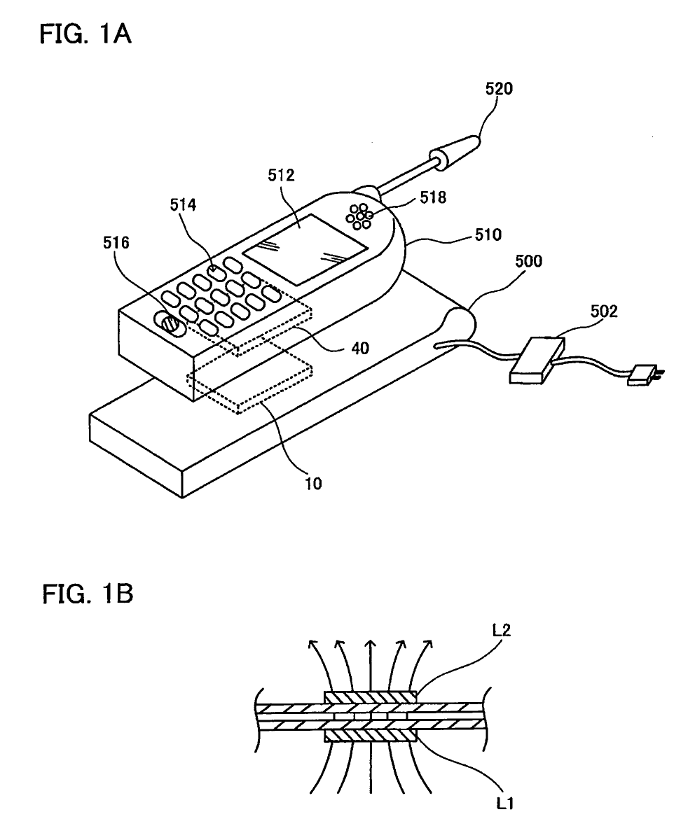

FIG 1A shows examples of an electronic instrument to which a non-contact power transmission method according to one embodiment of the invention is applied. A charger 500 (cradle) (i.e., electronic instrument) includes a power transmission device 10. A portable telephone 510 (i.e., electronic instrument) includes a power reception device 40. The portable telephone 510 also includes a display section 512 (e.g., LCD), an operation section 514 which includes a button or the like, a microphone 516 (sound input section), a speaker 518 (sound output section), and an antenna 520.

Power is supplied to the charger 500 through an AC adaptor 502. The power supplied to the charger 500 is transmitted from the power transmission device 10 to the power reception device 40 by means of non-contact power transmission. This makes it possible to charge a battery of the portable telephone 510 or operate a device provided in the portable telephone 510.

Note that the electronic instrument to which this embodiment is applied is not limited to the portable telephone 510. For example, this embodiment may be applied to various electronic instruments such as a wristwatch, a cordless telephone, a shaver, an electric toothbrush, a wrist computer, a handy terminal, a portable information terminal, and a power-assisted bicycle.

As schematically shown in FIG. 1B, power transmission from the power transmission device 10 to the power reception device 40 is implemented by electromagnetically coupling a primary coil L1 (power-transmission-side coil) provided in the power transmission device 10 and a secondary coil L2 (power-reception-side coil) provided in the power reception device 40 to form a power transmission transformer. This enables non-contact power transmission. Note that magnetic lines of force formed by the power transmission device 10 are not limited to those shown in FIG. 1B.

2. Power Transmission Device and Power Reception Device

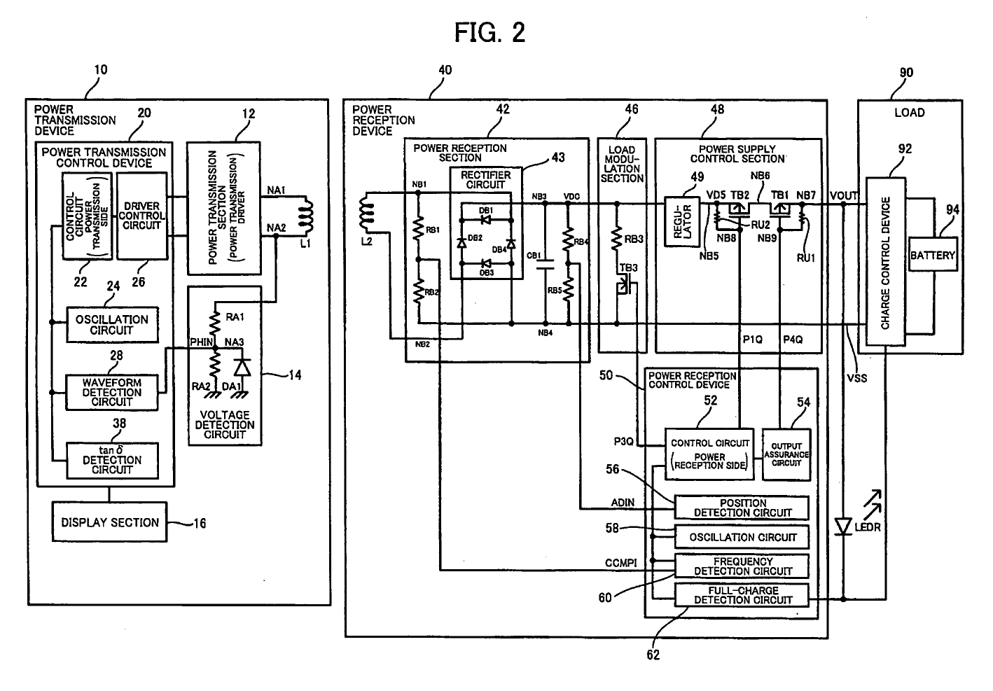

FIG. 2 shows a configuration example of the power transmission device 10, a power transmission control device 20, the power reception device 40, and a power reception control device 50 according to this embodiment. A power-transmission-side electronic instrument such as the charger 500 shown in FIG 1A includes at least the power transmission device 10 shown in FIG. 2. A power-reception-side electronic instrument such as the portable telephone 510 includes at least the power reception device 40 and a load 90 (actual load). The configuration shown in FIG. 2 implements a non-contact power transmission (contactless power transmission) system in which power is transmitted from the power transmission device 10 to the power reception device 40 by electromagnetically coupling the primary coil L1 and the secondary coil L2, and power (voltage VOUT) is supplied to the load 90 from a voltage output node NB7 of the power reception device 40.

The power transmission device 10 (power transmission module or primary module) may include the primary coil L1, a power transmission section 12, a voltage detection circuit 14, a display section 16, and the power transmission control device 20. The power transmission device 10 and the power transmission control device 20 are not limited to the configuration shown in FIG. 2. Various modifications may be made such as omitting some of the elements (e.g., display section and voltage detection circuit), adding other elements, or changing the connection relationship.

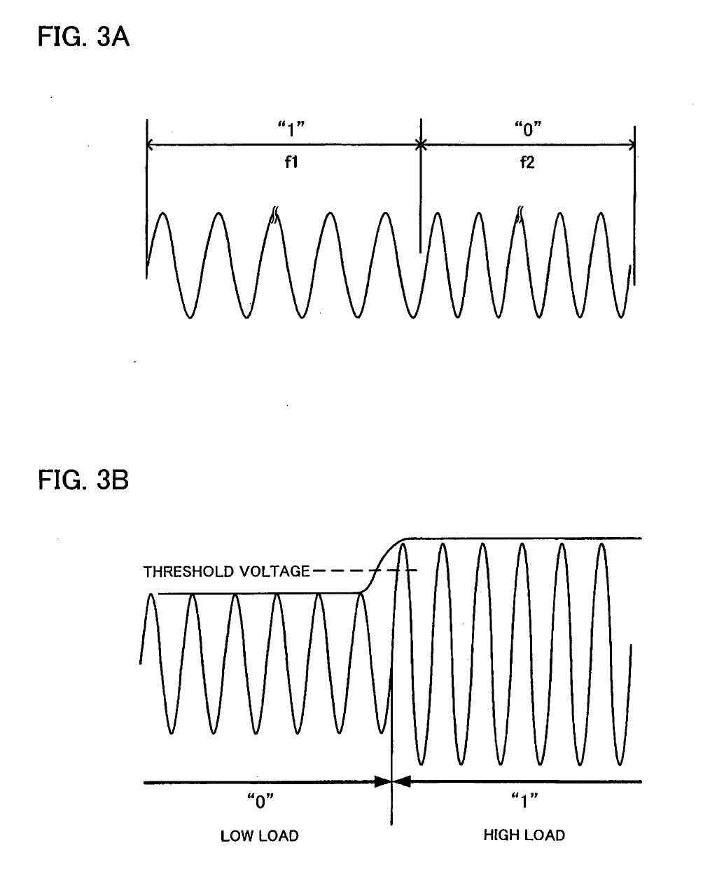

The power transmission section 12 generates an alternating-current voltage at a given frequency during power transmission, and generates an alternating-current voltage at a frequency that differs depending on data during data transfer. The power transmission section 12 supplies the generated alternating-current voltage to the primary coil L1. As shown in FIG. 3A, the power transmission section 12 generates an alternating-current voltage at a frequency f1 when transmitting data “1” to the power reception device 40, and generates an alternating-current voltage at a frequency f2 when transmitting data “0” to the power reception device 40, for example. The power transmission section 12 may include a first power transmission driver that drives one end of the primary coil L1, a second power transmission driver that drives the other end of the primary coil L1, and at least one capacitor that forms a resonant circuit with the primary coil L1.

Each of the first and second power transmission drivers included in the power transmission section 12 is an inverter circuit (buffer circuit) that includes a power MOS transistor, for example, and is controlled by a driver control circuit 26 of the power transmission control device 20.

The primary coil L1 (power-transmission-side coil) is electromagnetically coupled with the secondary coil L2 (power-reception-side coil) to form a power transmission transformer. When power transmission is necessary, the portable telephone 510 is placed on the charger 500 so that a magnetic flux of the primary coil L1 passes through the secondary coil L2, as shown in FIGS. 1A and 1B. When power transmission is unnecessary, the charger 500 and the portable telephone 510 are physically separated so that a magnetic flux of the primary coil L1 does not pass through the secondary coil L2.

The voltage detection circuit 14 is a circuit that detects the induced voltage in the primary coil L1. The voltage detection circuit 14 includes resistors RA1 and RA2 and a diode DA1 provided between a connection node NA3 of the resistors RA1 and RA2 and a power supply GND (first power supply in a broad sense), for example.

The voltage detection circuit 14 functions as a half-wave rectifier circuit for a coil end voltage signal of the primary coil L1. A signal PHIN (induced voltage signal or half-wave rectified signal) obtained by dividing the coil end voltage of the primary coil L1 using the resistors RA1 and RA2 is input to a waveform detection circuit 28 (amplitude detection circuit or pulse width detection circuit) of the power transmission control device 20. Specifically, the resistors RA1 and RA2 form a voltage divider circuit (resistor divider circuit), and the signal PHIN is output from the voltage division node NA3 of the resistors RA1 and RA2.

The display section 16 displays the state (e.g., power transmission or ID authentication) of the non-contact power transmission system using a color, an image, or the like. The display section 16 is implemented by an LED, an LCD, or the like.

The power transmission control device 20 controls the power transmission device 10. The power transmission control device 20 may be implemented by an integrated circuit device (control IC) or the like. The power transmission control device 20 may include a (power-transmission-side) control circuit 22, an oscillation circuit 24, a driver control circuit 26, the waveform detection circuit 28, and a temperature detection circuit (tan δ detection circuit) 38.

The control circuit 22 (control section) controls the power transmission device 10 and the power transmission control device 20. The control circuit 22 may be implemented by a gate array, a microcomputer, or the like. Specifically, the control circuit 22 performs sequence control and a determination process necessary for power transmission, load detection, frequency modulation, foreign object detection, detachment detection, and the like.

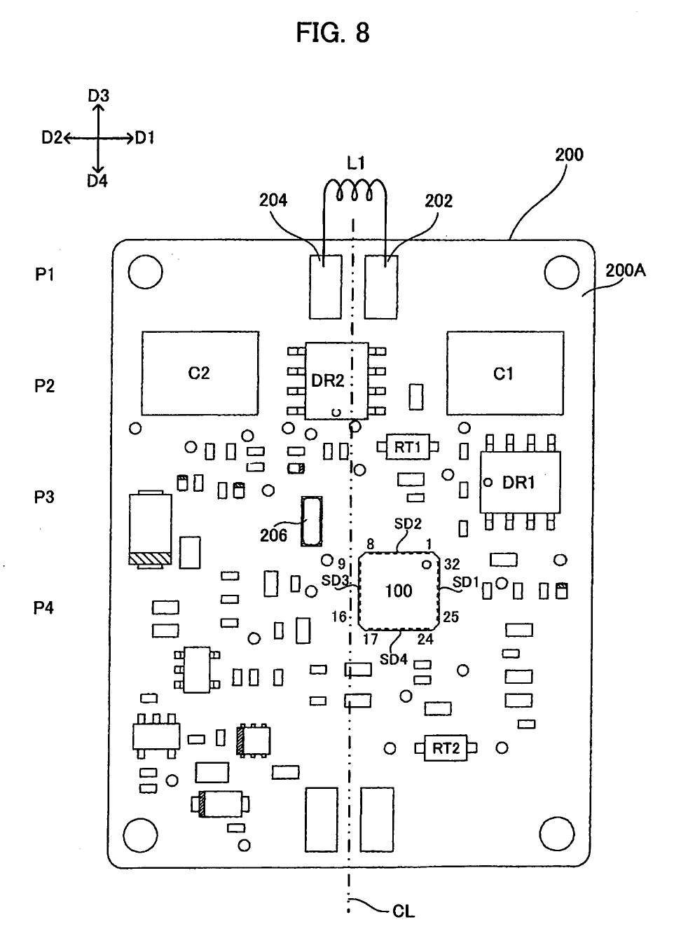

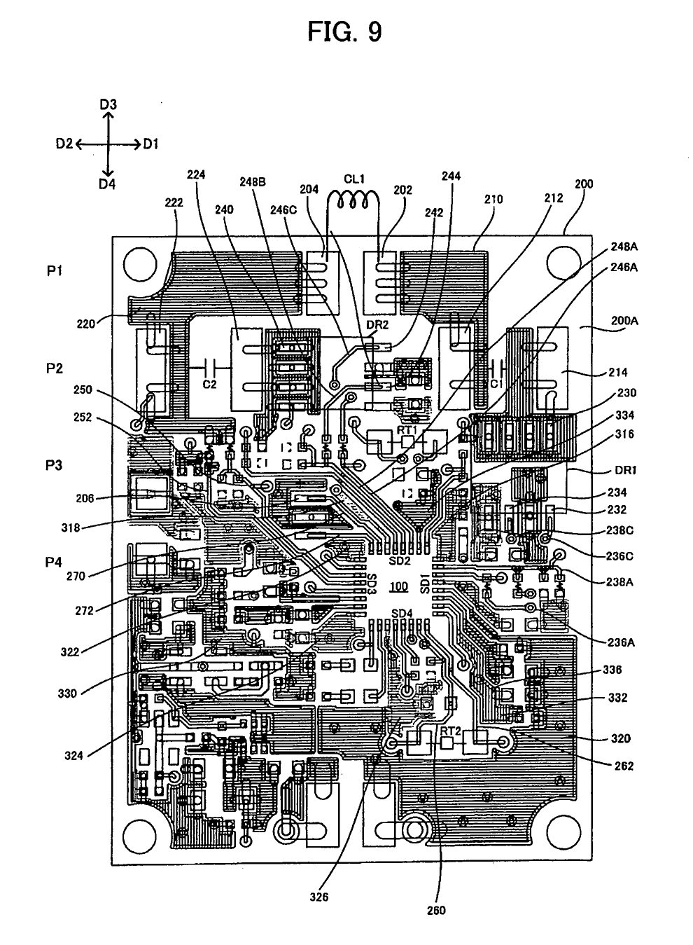

The oscillation circuit 24 includes a crystal oscillation circuit, for example. The oscillation circuit 24 generates a primary-side clock signal based on a reference clock signal from an external oscillator 206 (see FIGS. 8 and 9). The driver control circuit 26 generates a control signal at a desired frequency based on the clock signal generated by the oscillation circuit 24, a frequency setting signal from the control circuit 22, and the like, and outputs the control signal to the first and second power transmission drivers of the power transmission section 12 to control the first and second power transmission drivers.

The waveform detection circuit 28 monitors the waveform of the signal PHIN that corresponds to the induced voltage at one end of the primary coil L1, and detects a change in load on the secondary side (power reception device). This enables data (load) detection, foreign object (metal) detection, detachment (removal) detection, and the like. Specifically, the waveform detection circuit 28 (amplitude detection circuit) detects amplitude information (peak voltage, amplitude voltage, and root-mean-square voltage) relating to the signal PHIN that corresponds to the induced voltage at one end of the primary coil L1.

For example, when a load modulation section 46 of the power reception device 40 modulates load in order to transmit data to the power transmission device 10, the signal waveform of the induced voltage in the primary coil L1 changes as shown in FIG. 3B. Specifically, the amplitude (peak voltage) of the signal waveform decreases when the load modulation section 46 reduces load in order to transmit data “0”, and increases when the load modulation section 46 increases load in order to transmit data “1”. Therefore, the waveform detection circuit 28 can determine whether the data from the power reception device 40 is “0” or “1” by determining whether or not the peak voltage has exceeded a threshold voltage as a result of a peak-hold process on the signal waveform of the induced voltage, for example.

The load change detection method performed by the waveform detection circuit 28 is not limited to the method shown in FIGS. 3A and 3B. The waveform detection circuit 28 may determine whether the power-reception-side load has increased or decreased using a physical quantity other than the peak voltage. For example, the waveform detection circuit 28 (pulse width detection circuit) may detect pulse width information (pulse width period in which the coil end voltage waveform is equal to or higher than the given setting voltage) relating to the induced voltage signal PHIN of the primary coil L1. Specifically, the waveform detection circuit 28 receives a waveform adjusting signal from a waveform adjusting circuit that generates a waveform adjusting signal for the signal PHIN and a drive clock signal from a drive clock signal generation circuit that supplies the drive clock signal to the driver control circuit 26. The waveform detection circuit 28 may detect the pulse width information relating to the induced voltage signal PHIN by detecting pulse width information relating to the waveform adjusting signal to detect a change in load.

The tan δ detection circuit (temperature detection circuit) 38 detects an abnormality (failure) in tan δ of a capacitor used for non-contact power transmission. This capacitor is electrically connected at one end to the output of the power transmission driver of the power transmission section 12, and forms a resonant circuit (series resonant circuit) with the primary coil L1. The control circuit 22 stops power transmission using the power transmission drivers of the power transmission section 12 when an abnormality in tan δ of the capacitor has been detected. Specifically, the tan δ detection circuit 38 detects an abnormality in tan δ of the capacitor by calculating the difference between the capacitor temperature and the ambient temperature. The control circuit 22 stops power transmission from the primary side to the secondary side when determining that the difference between the capacitor temperature and the ambient temperature has exceeded a given temperature difference. The control circuit 22 may stop power transmission from the primary side to the secondary side when determining that the capacitor temperature has exceeded a given temperature.

The power reception device 40 (power reception module or secondary module) may include the secondary coil L2, a power reception circuit (power reception section) 42, a load modulation section 46, a power supply control section 48, and a power reception control device 50. Note that the power reception device 40 and the power reception control device 50 are not limited to the configuration shown in FIG. 2. Various modifications may be made such as omitting some of the elements, adding other elements, or changing the connection relationship.

The power reception section 42 converts an alternating-current induced voltage in the secondary coil L2 into a direct-current voltage. A rectifier circuit 43 included in the power reception circuit 42 converts the alternating-current induced voltage. The rectifier circuit 43 includes diodes DB1 to DB4. The diode DB2 is provided between a node NB1 at one end of the secondary coil L2 and a node NB3 (direct-current voltage VDC generation node). The diode DB2 is provided between the node NB3 and a node NB2 at the other end of the secondary coil L2. The diode DB3 is provided between the node NB2 and a node NB4 (VSS). The diode DB4 is provided between the nodes NB4 and NB1.

Resistors RB1 and RB2 of the power reception circuit 42 are provided between the nodes NB1 and NB4. A signal CCMPI obtained by dividing the voltage between the nodes NB1 and NB4 using the resistors RB1 and RB2 is input to a frequency detection circuit 60 of the power reception control device 50.

A capacitor CBI and resistors RB4 and RB5 of the power reception circuit 42 are provided between the node NB3 (direct-current voltage VDC) and the node NB4 (VSS). A signal ADIN obtained by dividing the voltage between the nodes NB3 and NB4 using the resistors RB4 and RB5 is input to a position detection circuit 56 of the power reception control device 50.

The load modulation section 46 performs a load modulation process. Specifically, when the power reception device 40 transmits desired data to the power transmission device 10, the load modulation section 46 variably changes the load of the load modulation section 46 (secondary side) depending on transmission data to change the signal waveform of the induced voltage in the primary coil L1 (see FIG. 3B). The load modulation section 46 includes a resistor RB3 and a transistor TB3 (N-type CMOS transistor) provided in series between the nodes NB3 and NB4. The transistor TB3 is ON/OFF-controlled based on a signal P3Q from a control circuit 52 of the power reception control device 50. When modulating load by ON/OFF-controlling the transistor TB3, transistors TB1 and TB2 of the power supply control section 48 are turned OFF so that the load 90 is electrically disconnected from the power reception device 40.

For example, when reducing the secondary-side load (high impedance) in order to transmit data “0”, as shown in FIG. 3B, the signal P3Q is set at the L level so that the transistor TB3 is turned OFF. As a result, the load of the load modulation section 46 becomes almost infinite (no load). On the other hand, when increasing the secondary-side load (low impedance) in order to transmit data “1”, the signal P3Q is set at the H level so that the transistor TB3 is turned ON. As a result, the load of the load modulation section 46 is equivalent to the resistor RB3 (high load).

The power supply control section 48 controls the amount of power supplied to the load 90. A regulator 49 regulates the voltage level of the direct-current voltage VDC obtained by conversion by the rectifier circuit 43 to generate a power supply voltage VD5 (e.g., 5 V). The power reception control device 50 operates based on the power supply voltage VD5 supplied from the power supply control section 48, for example.

A transistor TB2 (P-type CMOS transistor) is controlled based on a signal P1Q from the control circuit 52 of the power reception control device 50. Specifically, the transistor TB2 is turned ON when ID authentication has been completed (established) and normal power transmission is performed, and is turned OFF during load modulation or the like.

A transistor TB1 (P-type CMOS transistor) is controlled based on a signal P4Q from an output assurance circuit 54. Specifically, the transistor TB1 is turned ON when ID authentication has been completed and normal power transmission is performed. The transistor TB1 is turned OFF when connection of an AC adaptor has been detected or the power supply voltage VD5 is lower than the operation lower limit voltage of the power reception control device 50 (control circuit 52), for example.

The power reception control device 50 controls the power reception device 40. The power reception control device 50 may be implemented by an integrated circuit device (IC) or the like. The power reception control device 50 may operate based on the power supply voltage VD5 generated based on the induced voltage in the secondary coil L2. The power reception control device 50 may include the (power-reception-side) control circuit 52, the output assurance circuit 54, the position detection circuit 56, an oscillation circuit 58, the frequency detection circuit 60, and a full-charge detection circuit 62.

The control circuit 52 (control section) controls the power reception device 40 and the power reception control device 50. The control circuit 52 may be implemented by a gate array, a microcomputer, or the like. Specifically, the control circuit 22 performs sequence control and a determination process necessary for ID authentication, position detection, frequency detection, load modulation, full-charge detection, and the like.

The output assurance circuit 54 is a circuit that assures the output from the power reception device 40 when the voltage is low (0 V). The output assurance circuit 54 prevents a backward current flow from the voltage output node NB7 to the power reception device 40.

The position detection circuit 56 monitors the waveform of the signal ADIN that corresponds to the waveform of the induced voltage in the secondary coil L2, and determines whether or not the primary coil L1 and the secondary coil L2 have an appropriate positional relationship. Specifically, the position detection circuit 56 converts the signal ADIN into a binary value using a comparator to determine whether or not the primary coil L1 and the secondary coil L2 have an appropriate positional relationship.

The oscillation circuit 58 includes a CR oscillation circuit, for example. The oscillation circuit 58 generates a secondary-side clock signal. The frequency detection circuit 60 detects the frequency (f1 or f2) of the signal CCMPI, and determines whether the data transmitted from the power transmission device 10 is “1” or “0”, as shown in FIG. 3A.

The full-charge detection circuit 62 (charge detection circuit) is a circuit which detects whether or not a battery 94 (secondary battery) of the load 90 has been fully charged (completely charged).

The load 90 includes a charge control device 92 that controls charging of the battery 94 and the like. The charge control device 92 (charge control IC) may be implemented by an integrated circuit device or the like. The battery 94 may be provided with the function of the charge control device 92 (e.g., smart battery).

3. Detection of Abnormality in tan δ

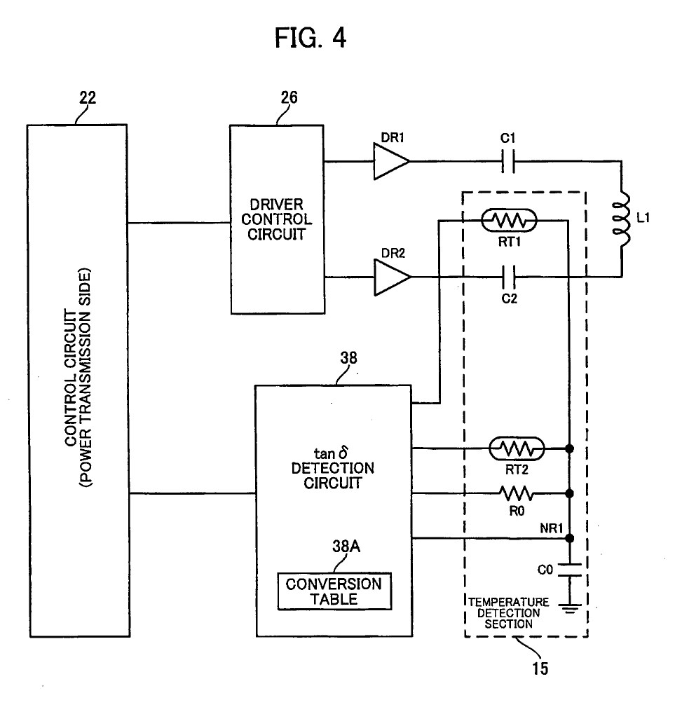

FIG. 4 shows a specific configuration example of the power transmission control device 20 according to this embodiment. In FIG. 4, the driver control circuit 26 generates driver control signals, and outputs the driver control signals to the first and second power transmission drivers DR1 and DR2 which drive the primary coil L1. A capacitor C1 is provided between the output of the power transmission driver DR1 and the primary coil L1, and a capacitor C2 is provided between the output of the power transmission driver DR2 and the primary coil L1. A series resonant circuit is formed by the capacitors C1 and C2 and the primary coil L1. Note that the configuration of the resonant circuit is not limited to the configuration shown in FIG. 4. For example, one of the capacitors C1 and C2 may be omitted.

The tan δ detection circuit 38 (temperature measurement circuit) detects an abnormality (failure) in tan δ of the capacitors C1 and C2. Note that the tan δ detection circuit 38 may detect an abnormality in tan δ of both or one of the capacitors C1 and C2. The control circuit 22 stops power transmission using the power transmission drivers DR1 and DR2 when an abnormality in tan δ has been detected. For example, the control circuit 22 outputs a drive stop signal to the driver control circuit 26, and the driver control circuit 26 stops outputting the driver control signals to the power transmission drivers DR1 and the DR2. Alternatively, the control circuit 22 causes the drive clock signal generation circuit to stop supplying the drive clock signal for the driver control circuit 26 to generate the driver control signals. This causes the power transmission drivers DR1 and the DR2 to stop driving the primary coil L1 so that non-contact power transmission stops.

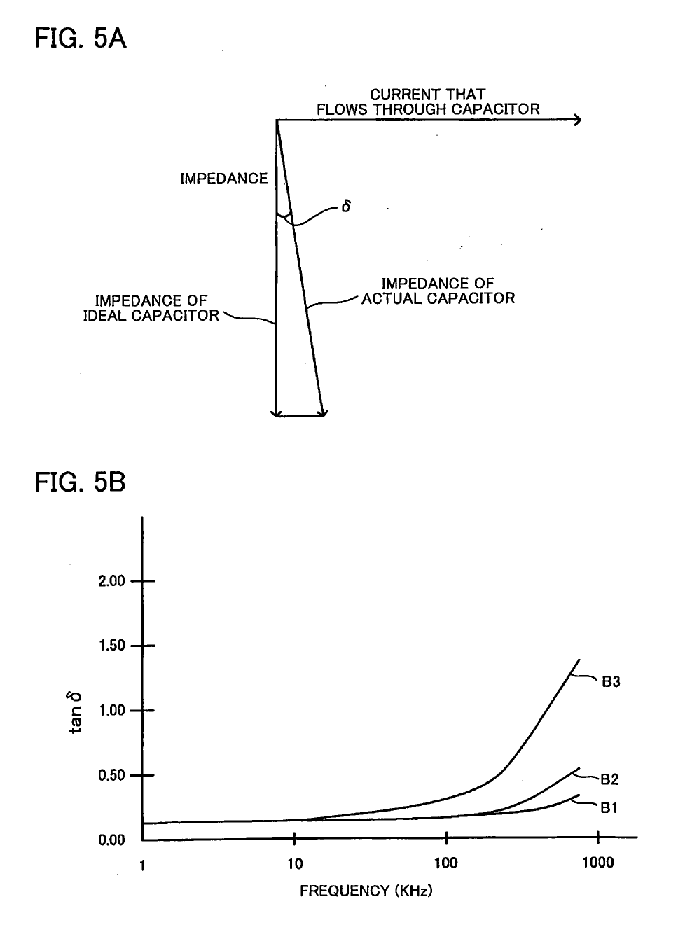

For example, the phase of a sine-wave current which flows through an ideal capacitor is shifted with respect to the phase of the voltage by 90 degrees. On the other hand, the phase shift of an actual capacitor is reduced by an angle δ due to dielectric loss caused by parasitic resistance and the like. As shown in FIG. 5A, an actual capacitor is considered to have a loss corresponding to Zc×tan δ with respect to the impedance (−jZc, Zc=1/2πfc) of an ideal capacitor. The capacitor generates heat due to such a loss. tan δ is referred to as a dielectric dissipation factor, which is an important parameter that indicates the performance of a capacitor.

FIG. 5B shows tan δ values measured for capacitors. A symbol B1 indicates a tan δ value measured for a normal product, and symbols B2 and B3 indicate tan δ values measured for abnormal products. An increase in tan δ of the normal product (B1) is small even if the frequency increases. On the other hand, the tan δ of the abnormal products (B2 and B3) increases to a large extent as the frequency increases. For example, a capacitor which has a normal tan δ value before being mounted on a circuit board may have an abnormal tan δ value due to soldering heat or the like during mounting.

The power transmission drivers DR1 and the DR2 shown in FIG. 4 drive the primary coil L1 at a high drive frequency (alternating-current frequency) of 100 to 500 KHz, for example. A large alternating current of about several hundreds of mA to 1 A flows through the primary coil L1 and the resonant capacitors C1 and C2 (a current of several tens of mA flows through other components). Therefore, heat may be generated due to dielectric loss when the capacitor has an abnormal tan δ value, whereby the capacitors C1 and C2 may break.

As shown in FIG. 5B, when the drive frequency is low, a serious problem does not occur even if the capacitor has an abnormal tan δ value. Therefore, an abnormality in tan δ of the capacitor has not been taken into consideration.

However, in order to improve the efficiency and stability of non-contact power transmission and reduce power consumption due to non-contact power transmission, it is desirable to set the drive frequency at a value sufficiently higher than the resonance frequency of the resonant circuit. When the drive frequency is increased to 100 KHz or more, for example, the capacitor may generate heat and break when the capacitor has an abnormal tan δ value.

In order to prevent such a situation, this embodiment employs a method that detects an abnormality in tan δ of the capacitor and stops power transmission from the primary side to the secondary side when an abnormality has been detected. For example, power transmission is stopped when the difference between the capacitor temperature and the ambient temperature has increased or the capacitor temperature has increased (i.e., an abnormality has been detected).

Specifically, a temperature detection section 15 shown in FIG. 4 includes a reference resistor RO, a capacitor temperature measurement thermistor (first thermistor) RT1, and an ambient temperature measurement thermistor (second thermistor) RT2. The thermistor RT1 is disposed near the capacitors C1 and C2, and the thermistor RT2 is disposed at a distance from the capacitors C1 and C2. For example, the reference resistor RO and the thermistors RT1 and RT2 are provided as external components on a circuit board on which an IC of the power transmission control device 20 is mounted. The thermistor RT1 is provided near the capacitors C1 and C2, and the thermistor RT2 is provided at a distance from the capacitors C1 and C2. The thermistor is a resistor of which the electrical resistance changes to a large extent with respect to a change in temperature.

The tan δ detection circuit 38 measures temperature using a resistance-frequency conversion (RF conversion) method. Specifically, the tan δ detection circuit 38 measures the capacitor temperature by calculating first resistance ratio information (first count value or CR oscillation time within reference measurement time) which is resistance ratio information relating to the reference resistor RO and the capacitor temperature measurement thermistor RT1. The tan δ detection circuit 38 measures the ambient temperature by calculating second resistance ratio information (second count value or CR oscillation time within reference measurement time) which is resistance ratio information relating to the reference resistor RO and the ambient temperature measurement thermistor RT2. The tan δ detection circuit 38 detects whether or not an abnormality in tan δ of the capacitor has occurred by calculating the difference between the capacitor temperature and the ambient temperature thus measured.

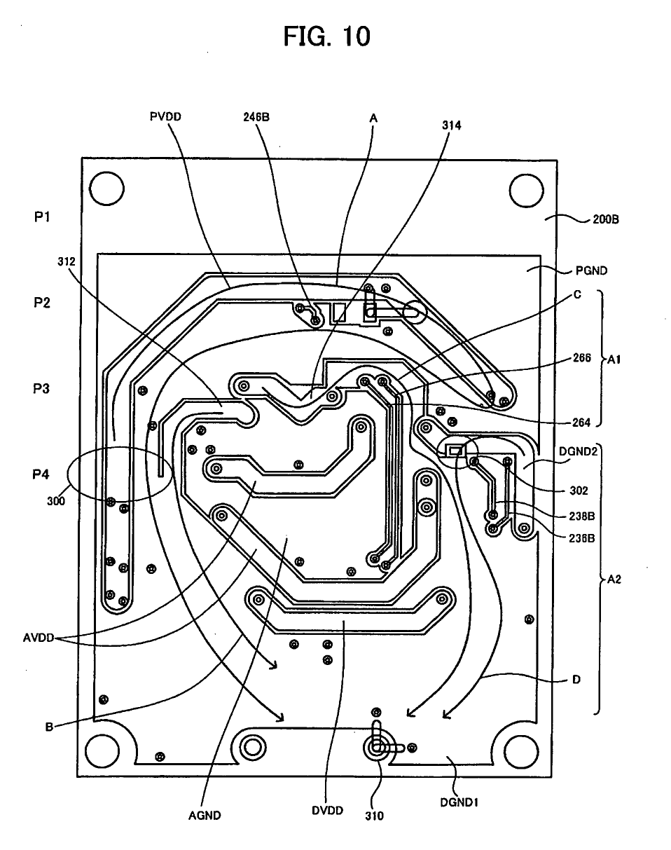

Specifically, the thermistors RT1 and RT2 have a negative temperature coefficient, for example. The resistances of the thermistors RT1 and RT2 decrease as the temperature increases (see FIG. 10 described later). Therefore, the capacitor temperature and the ambient temperature can be measured by calculating the first resistance ratio information relating to the reference resistor RO and the thermistor RT1 and the second resistance ratio information relating to the reference resistor RO and the thermistor RT2. A change in the capacitance of the reference capacitor C0, the power supply voltage, or the like can be absorbed by measuring the temperature based on the resistance ratio of the reference resistor RO and the thermistor RT1 or RT2, whereby the temperature measurement accuracy can be improved.

When detecting an abnormality in tan δ of the capacitor based only on the capacitor temperature, an abnormality in tan δ may not be detected when the capacitor temperature does not increase due to a low ambient temperature. For example, when the ambient temperature is 5° C. and the capacitor temperature is 30° C., an abnormality in tan δ cannot be detected even though the capacitor generates heat in an amount corresponding to 25° C. Therefore, a capacitor having an abnormal tan δ value is overlooked.

In FIG. 4, an abnormality in tan δ is detected based on the difference between the capacitor temperature and the ambient temperature. For example, when the ambient temperature is 5° C. and the capacitor temperature is 30° C., an abnormality in tan δ is detected since the difference between the capacitor temperature and the ambient temperature is 25° C. Therefore, generation of heat from the capacitor due to an abnormality in tan δ can be detected quickly and reliably independent of the ambient environment so that reliability can be improved.

The tan δ detection circuit 38 includes a conversion table 38A for converting the resistance ratio information into temperature. The conversion table 38A may be implemented by a memory such as a ROM. The conversion table 38A may also be implemented by a combinational circuit or the like.

The tan δ detection circuit 38 determines the capacitor temperature based on the conversion table 38A and the first resistance ratio information, and determines the ambient temperature based on the conversion table 38A and the second resistance ratio information. Specifically, the tan δ detection circuit 38 reads conversion information for converting the resistance ratio information into temperature from the conversion table 38A, for example, and converts the first resistance ratio information (first count value) into the capacitor temperature or converts the second resistance ratio information (second count value) into the ambient temperature based on the conversion information.

More specifically, the conversion table 38A stores first conversion information (CN) for calculating the number of tens of the temperature (temperature in units of 10° C.) and second conversion information (AN) for calculating the number of units of the temperature (temperature in units of 1° C.) as the conversion information.

The tan δ detection circuit 38 specifies the number of tens of the temperature corresponding to the first resistance ratio information (first count value) based on the first conversion information stored in the conversion table 38A. The tan δ detection circuit 38 calculates the number of units of the temperature corresponding to the first resistance ratio information by linear interpolation (interpolation calculations) using the second conversion information stored in the conversion table 38A to convert the first resistance ratio information (first count value) into data relating to the capacitor temperature.

The tan δ detection circuit 38 specifies the number of tens of the temperature corresponding to the second resistance ratio information (second count value) based on the first conversion information stored in the conversion table 38A. The tan δ detection circuit 38 calculates the number of units of the temperature corresponding to the second resistance ratio information by linear interpolation (interpolation calculations) using the second conversion information stored in the conversion table 38A to convert the second resistance ratio information (second count value) into data relating to the ambient temperature.

A linear interpolation conversion process can be performed using the conversion table 38A while regarding characteristics within each of a plurality of temperature ranges obtained by dividing the measured temperature range as pseudo linear characteristics, even if the temperature-thermistor resistance conversion characteristics are not linear characteristics. This enables the scale of the tan δ detection circuit 38 to be reduced while simplifying the process performed by the tan δ detection circuit 38. Moreover, a temperature conversion process can be implemented over a wide temperature range (e.g., −30 to 120° C.) by performing linear interpolation within each temperature range. This enables an abnormality in tan δ to be detected over a wide measurement temperature range so that reliability can be improved.

4. Control IC

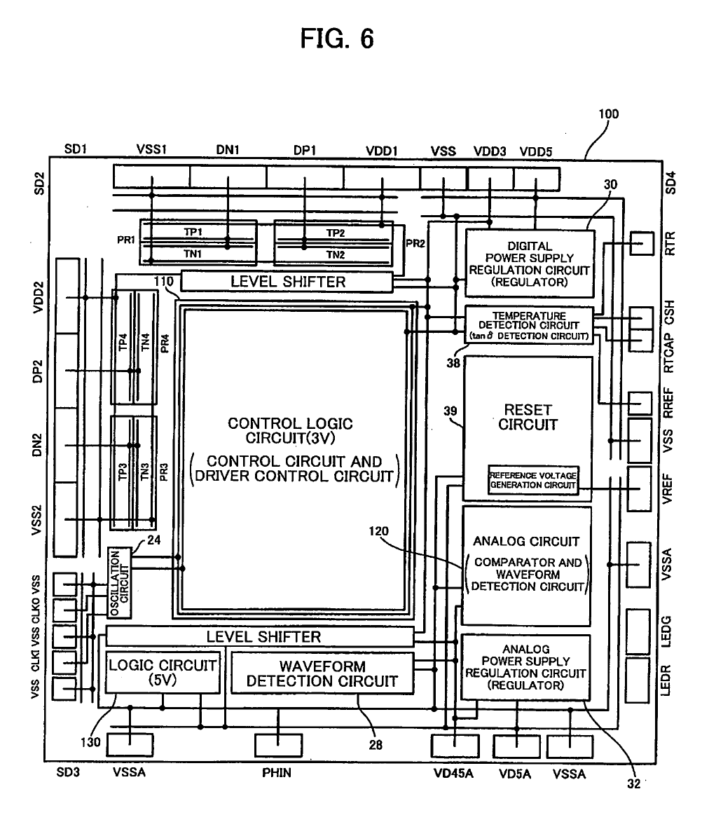

A control IC 100 shown in FIG. 6 includes the oscillation circuit 24, the waveform detection circuit 28, the temperature detection circuit 38 (see FIG. 2), a digital power supply regulation circuit 30, an analog power supply regulation circuit 32, a reset circuit 39, a control logic circuit 110, an analog circuit 120, and a logic circuit 130.

The control logic circuit 110 includes the power-transmission-side control circuit 22 and the driver control circuit 26 shown in FIG. 2. The control logic circuit 110 includes logic cells (e.g., NAND, NOR, inverter, and D flip-flop), and operates based on a digital power supply voltage VDD3 regulated by the digital power supply regulation circuit 30. The control logic circuit 110 may be implemented by a gate array, a microcomputer, or the like, and performs sequence control and a determination process. The control logic circuit 110 controls the entire control IC 100.

The digital power supply regulation circuit 30 (digital power supply regulator or digital constant voltage generation circuit) regulates a digital power supply (digital power supply voltage or logic power supply voltage). For example, the digital power supply regulation circuit 30 regulates a 5 V digital power supply voltage VDD5 input from the outside, and outputs a 3 V digital power supply voltage VDD3 at a stable potential.

The analog power supply regulation circuit 32 (analog power supply regulator or analog constant voltage generation circuit) regulates an analog power supply (analog power supply voltage). For example, the analog power supply regulation circuit 32 regulates a 5 V analog power supply voltage VD5A input from the outside, and outputs a 4.5 V analog power supply voltage VD45A at a stable potential.

The digital power supply regulation circuit 30 and the analog power supply regulation circuit 32 may be formed using a known series regulator, for example. The series regulator may include a driver transistor provided between a high-potential-side power supply and an output node, a voltage divider circuit that is provided between the output node and a low-potential-side power supply and divides an output voltage using resistors, and an operational amplifier, a reference voltage being input to a first input terminal (e.g., non-inverting input terminal) of the operational amplifier, the resistor-divided voltage from the voltage divider circuit being input to a second input terminal (e.g., inverting input terminal) of the operational amplifier, and an output terminal of the operational amplifier being connected to the gate of the driver transistor, for example. The analog power supply regulation circuit 32 may be a circuit that generates an analog GND voltage and supplies the analog GND voltage to the analog circuit 120.

The reset circuit 39 generates a reset signal, and output the reset signal to each circuit of the integrated circuit device. Specifically, the reset circuit 39 monitors a power supply voltage supplied from the outside, a digital power supply (logic power supply) voltage regulated by the digital power supply regulation circuit 30, and an analog power supply voltage regulated by the analog power supply regulation circuit 32. The reset circuit 39 cancels the reset signal when the power supply voltage has risen appropriately so that each circuit of the integrated circuit device starts operation to implement a power-on reset process.

The analog circuit 120 includes a comparator, an operational amplifier, and the like, and operates based on the analog power supply voltage VD45A regulated by the analog power supply regulation circuit 32. Specifically, the analog circuit 120 performs an analog process using one or more comparators and one or more operational amplifiers. More specifically, the analog circuit 120 may include a detection circuit that performs various detection processes such as amplitude detection (peak detection), pulse width detection, phase detection, and frequency detection, a determination circuit that performs a determination process using an analog voltage, an amplifier circuit that amplifies an analog signal, a current-mirror circuit, an A/D conversion circuit that converts an analog voltage into a digital voltage, and the like. The logic circuit 130 performs a digital process.

The control IC 100 is formed in the shape of a quadrangle, and has a first side SD1, a second side SD2, a third side SD3, and a fourth side SD4.

The control IC 100 includes predrivers PR1, PR2, PR3, and PR4. In FIG. 6, the predrivers PR1 and PR2 are disposed along the first side SD1 of the control IC 100, and the predrivers PR3 and PR4 are disposed along the second side SD2 perpendicular to the first side SD1. The predrivers PR1, PR2, PR3, and PR4 are formed using complementary transistors (TP1 and TN1), (TP2 and TN2), (TP3 and TN3), and (TP4 and TN4).

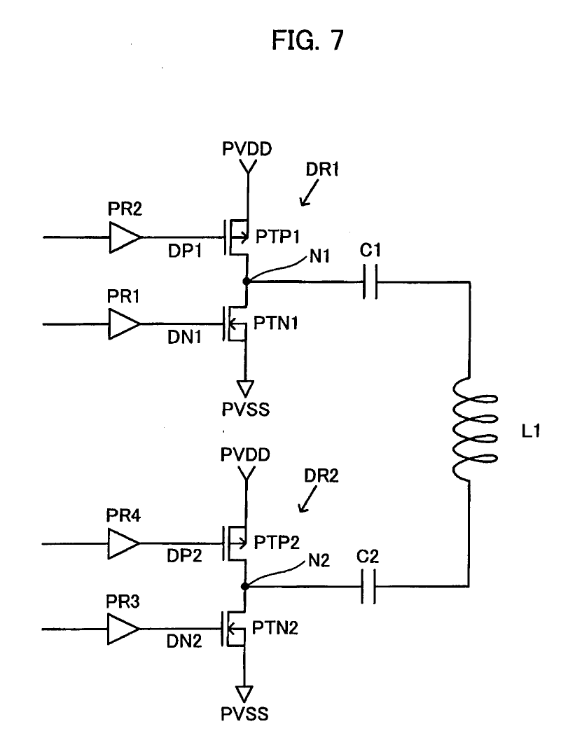

In FIG. 7, the first transmission driver DR1 is provided outside the control IC 100, for example. The first transmission driver DR1 includes an N-type power MOS transistor PTN1 (N-type transistor or N-type MOS transistor in a broad sense) and a P-type power MOS transistor PTP1 (P-type transistor or P-type MOS transistor in a broad sense) as external components. The first transmission driver DR1 may be a power transmission driver that drives a primary coil in non-contact power transmission, a motor driver that drives a motor, or the like.

The predriver PR1 drives the N-type power MOS transistor PTN1 of the first transmission driver DR1. Specifically, an inverter circuit that includes an N-type transistor and a P-type transistor may be used as the predriver PR1. A driver control signal DN1 from the predriver PR1 is input to the gate of the N-type power MOS transistor PTN1 through an output pad so that the transistor PTN1 is ON/OFF-controlled.

The predriver PR2 drives the P-type power MOS transistor PTP1 of the first transmission driver DR1. Specifically, an inverter circuit that includes an N-type transistor and a P-type transistor may be used as the predriver PR2. A driver control signal DP1 from the predriver PR2 is input to the gate of the P-type power MOS transistor PTP1 through an output pad so that the transistor PTP1 is ON/OFF-controlled.

The driver control signals DN1 and DP1 are non-overlap signals of which the active periods do not overlap. This prevents a situation in which a shoot-through current flows from the high-potential-side power supply to the low-potential-side power supply through the transistors.

The predrivers PR3 and PR4 drive transistors PTN2 and PTP2 of the second transmission driver DR2 shown in FIG. 7 based on driver control signals DN2 and DP2. The predrivers PR3 and PR4 operate in the same manner as the predrivers PR1 and PR2.

In FIG. 7, nodes N1 and N2 of the first and second transmission drivers DR1 and DR2 are connected to the ends of the primary coil L1 through the resonant capacitors C1 and C2. The resonant capacitors C1 and C2 form a series resonant circuit with the primary coil. Note that only one of the capacitors C1 and C2 may be provided.

The P-type power MOS transistor PTP1 and the N-type power MOS transistor PTN1 of the first transmission driver DR1 are connected in series between a power power supply potential PVDD and a power ground power supply potential PVSS. Likewise, the P-type power MOS transistor PTP2 and the N-type power MOS transistor PTN2 of the second transmission driver DR2 are connected in series between the power power supply potential PVDD and the power ground power supply potential PVSS. Therefore, a large high-frequency analog alternating current flows through the primary coil L1, the first and second resonant capacitors C1 and C2, and the first and second transmission drivers DR1 and DR2 (power circuits) by controlling the first and second transmission drivers DR1 and DR2.

Various terminals are provided on the first side SD1, the second side SD2, the third side SD3, and the fourth side SD4 of the control IC 100 shown in FIG. 6. Output terminals of the driver control signals DN1 and DP1 are provided on the first side SD1, and output terminals of the driver control signals DN2 and DP2 are provided on the second side SD2. A terminal connected to the oscillation circuit 24 is provided on the second side SD2, and an input terminal of the induced voltage signal PHIN input to the waveform detection circuit 28 is provided on the third side SD3. A terminal of a temperature detection signal input to the temperature detection circuit 38 is provided on the fourth side SD4.

5. Layout of Main Components on Mounting Surface of Printed Circuit Board

FIG. 8 shows main components disposed on a mounting surface 200A of a printed circuit board 200 of the power transmission device 10. In FIG. 8, the centerline that divides the printed circuit board 200 in two in the horizontal direction is referred to as CL, the rightward direction (e.g., first direction) is referred to as D1, the leftward direction (for example second direction) is referred to as D2, the upward direction is referred to as D3, the downward direction is referred to as D4, and row positions from the end of the printed circuit board 200 in the upward direction D3 are referred to as first to fourth row positions P1 to P4. The layout of the main components is described below.

In FIG. 8, first and second coil connection terminals 202 and 204 connected to the ends of the primary coil L1 are disposed in the first row position P1 that is the end of the printed circuit board 200 in the direction D3 at line-symmetrical positions with respect to the centerline CL, for example.

The control IC 100 is disposed in approximately the center area (e.g., fourth row position P4) of the printed circuit board 200 at a position shifted in the first direction D1 with respect to the centerline CL. The first side SD1 and the third side SD3 are parallel to the centerline CL, and the second side SD3 faces the coil connection terminals 202 and 204.

The first and second resonant capacitors C1 and C2 are provided as resonant capacitors that form a series resonant circuit with the primary coil CL1. The first and second resonant capacitors C1 and C2 are disposed in the second row position P2 of the printed circuit board 200 adjacent to the first row position P1 at line-symmetrical positions with respect to the centerline CL, for example. Note that one of the first and second resonant capacitors C1 and C2 may be omitted, as described above.

The first and second power transmission drivers DR1 and DR2 that drive the primary coil L1 through the first and second coil connection terminals 202 and 204 are disposed between the first row position P1 and the fourth row position P4 in which the control IC 100 is disposed. The first transmission driver DR1 is disposed in the third row position P3 between the second row position P1 and the fourth row position P4 of the printed circuit board 200, and is disposed at a position shifted in the first direction D1 with respect to the first side SD1 of the control IC 100, for example. The second transmission driver DR2 is disposed between the first and second resonant capacitors C1 and C2 in the second row position P2 to face the second side SD3 of the control IC 100, for example.

The first thermistor RT1 that measures the temperature of the resonant capacitor (particularly the first resonant capacitor C1) is disposed in the third row position P3 close to the first resonant capacitor C1 at a position shifted in the first direction D1 with respect to the centerline CL.

The thermistor RT2 that measures the ambient temperature is disposed at a position away from the first and second resonant capacitors C1 and C2 (e.g., at a position shifted in the direction D4 with respect to the fourth side SD4 of the control IC 100).

The oscillator 206 supplies the reference clock signal to the oscillation circuit 24 of the control IC 100 shown in FIG. 6. The oscillator 206 is disposed in the third row position P3 of the printed circuit board 100 close to the corner (position of the input terminal connected to the oscillation circuit 24) of the second side SD2 of the control IC 100 in the direction D2.

6. Layout of Wiring Pattern on Mounting Surface of Printed Circuit Board

FIG. 9 shows a wiring pattern on the mounting surface 200A of the printed circuit board 200. First and second wide patterns 210 and 220 are respectively connected to the first and second coil connection terminals 202 and 204. The first wide pattern 210 is connected to a terminal pattern 212 of the first resonant capacitor C1. The first resonant capacitor C1 is connected to the terminal pattern 212 and a terminal pattern 214 disposed opposite to the terminal pattern 212. The second wide pattern 220 is connected to a terminal pattern 222 of the second resonant capacitor C2. The second resonant capacitor C2 is connected to the terminal pattern 222 and a terminal pattern 224 disposed opposite to the terminal pattern 222. The second wide pattern 220 is also used as part of a waveform detection wiring pattern for the waveform detection signal PHIN.

The node N1 (see FIG. 7) of the first transmission driver DR1 is connected to a node terminal pattern 230. The gates of the transistors PTP1 and PTN1 (see FIG. 7) of the first transmission driver DR1 are connected to gate terminal patterns 232 and 234. Likewise, the node N1 (see FIG. 7) of the second transmission driver DR1 is connected to a node terminal pattern 240. The gates of the transistors PTP2 and PTN2 (see FIG. 7) of the first transmission driver DR2 are connected to gate terminal patterns 242 and 244.

As described above, the coil connection terminals 202 and 204 and the first and second resonant capacitors C1 and C2 are disposed in the first and second row positions P1 and P2 on the end of the printed circuit board 200, and the first and second transmission drivers DR1 and DR2 are respectively disposed in the second row position P2 and the right area of the third row position P3 (i.e., position shifted in the first direction). Specifically, the power circuits (primary coil CL1, first and second resonant capacitors C1 and C2, and first and second transmission drivers DR1 and DR2) which require a large amount of high-frequency power (e.g., about several hundreds of mA to 1 A at 5 V) are collectively disposed in the first and second row positions and the right area of the third row position P3 (position shifted in the first direction) of the printed circuit board 200. As a result, a path for a large current that flows through the power circuits can be collectively provided in the first and second row positions of the printed circuit board 200. Moreover, since the power components are disposed adjacently, current loss can be reduced.

The control IC 100 has 32 pins, as shown in FIG. 8. The pin provided on the right end of the second side SD2 has a pin number 1. The pin number increases counter-clockwise, and the pin provided on the upper end of the first side SD1 has a pin number 32.

Wiring patterns 236A to 236C and 238A to 238C are provided that supply the driver control signals DP1 and DN1 (see FIG. 7) from two terminals (pin numbers 30 and 31) on the first side SD1 of the control IC 100 to the gate terminals 232 and 234. The wiring patterns 236B and 238B are provided on a back surface 200B (see FIG. 10 described later) of the printed circuit board 200, and are connected to the wiring patterns 236A, 236C, 238A, and 238C on the mounting surface 200A via through-holes.

Likewise, wiring patterns 246A to 246C, 248A, and 248B are provided that supply the driver control signals DP2 and DN2 (see FIG. 7) from two terminals (pin numbers 3 and 4) on the second side SD2 of the control IC 100 to the gate terminals 242 and 244. The wiring pattern 246B is provided on the back surface 200B (see FIG. 10 described later) of the printed circuit board 200, and is connected to the wiring patterns 246A and 246C on the mounting surface 200A via through-holes.

As described above, the control IC 100 having the terminals through which the driver control signals DP1, DN1, DP2, and DN2 are output on the first and second sides SD1 and SD2 is shifted in the first direction D1 with respect to the centerline CL, and the first and second transmission drivers DR1 and DR2 are disposed at positions close to the first and second sides SD1 and SD2. Therefore, paths for a current synchronized with a current that flows through the power circuits can be collectively provided in the area shifted in the first direction D1 with respect to the centerline CL.

The first and second transmission drivers DR1 and DR2 may be line-symmetrically disposed with respect to the centerline CL at positions close to the first and second resonant capacitors C1 and C2. In this case, paths for a current synchronized with a current that flows through the power circuits are formed in almost the entire area in the third row position P3 of the printed circuit board 200. When providing wiring patterns for a small analog signal and a digital signal are provided in the third row position P3 of the printed circuit board 200, the small analog signal and the digital signal are adversely affected by a large analog current. According to this embodiment, since a large analog current and a current synchronized with a large analog current do not flow in the left area (area shifted in the second direction D2) of the third and fourth row positions P3 and P4 of the printed circuit board 200 shown in FIG. 8, this area can be effectively utilized.

It is necessary to input the waveform detection signal PHIN to the input terminals (pin numbers 11 and 12) provided on the third side SD3 of the control IC 100 from the second coil connection terminal 204 of the primary coil L1, as described above. Since the waveform detection signal PHIN is a small analog signal with a current of several tens of mA at a voltage of 5 V, it is necessary to prevent interference between the waveform detection signal PHIN and a large analog current.

In this embodiment, waveform voltage detection patterns (narrow patterns) 250 and 252 through which the waveform detection signal PHIN is transmitted extend from the input terminals (pin numbers 11 and 12) provided on the third side SD3 of the control IC 100, pass over an area of the printed circuit board 200 positioned in the second direction D2 with respect to the centerline CL (an area on the left and the upper left of the control IC 100 in FIG. 9), and are connected to the second wide pattern 220. Since the second wide pattern 220 disposed in the first and second row positions P1 and P2 has a large pattern width, the potential of the waveform detection signal PHIN is stabilized. The waveform voltage detection patterns (narrow patterns) 250 and 252 easily interfere with a large-current analog signal. However, since a large analog current and a current synchronized with a large analog current do not flow in the left area (area shifted in the second direction D2) of the third and fourth row positions P3 and P4 of the printed circuit board 200 shown in FIG. 8, noise is rarely superimposed on the waveform detection signal PHIN.

As shown in FIG. 9, the thermistor (first thermistor) RT1 that measures the temperature of the first resonant capacitor C1 and the thermistor (second thermistor) RT2 that measures the ambient temperature are connected to the terminals (pin numbers 22 to 24) provided on the fourth side SD4 of the control IC 100, for example.

Since the second thermistor RT2 is disposed to face the fourth side SD4 of the control IC 100, wiring patterns 260 and 262 connected to the second thermistor RT2 can be easily provided.

On the other hand, since the first thermistor RT1 is disposed at a position close to the first resonant capacitor C1, the first thermistor RT1 cannot be disposed to face the fourth side SD4 of the control IC 100. Therefore, the first thermistor RT1 is disposed in the upward direction D3 with respect to the second side SD2. A path from the first thermistor RT1 to the left side of the control IC 100 is blocked by the wiring patterns 246A, 248A, and the like connected to the second transmission driver DR2. A path from the first thermistor RT1 to the right side of the control IC 100 is blocked by the wiring patterns 236A, 238A, and the like connected to the first transmission driver DR2.

Therefore, the first thermistor RT1 and the terminal on the fourth side SD4 of the control IC 100 are connected through the wiring patterns 260 and 262 provided on the back surface 200B of the printed circuit board 200.

As shown in FIG. 9, the oscillator 206 is provided between the wiring patterns 246A and 248A and the wiring patterns 250 and 252, and is connected to the terminals (pin numbers 7 and 8) provided on the second side SD2 of the control IC 100 through the wiring patterns 270 and 272 that extend between the wiring patterns 246A and 248A and the wiring patterns 250 and 252. Since the reference clock signal from the oscillator 206 is synchronized with a current that flows through the wiring patterns 246A and 248A, an adverse effect occurs to only a small extent even if the wiring patterns 270 and 272 are adjacent to the wiring patterns 246A and 248A.

7. Power Supply Pattern on Back Surface of Printed Circuit Board

As shown in FIG. 10, power supply patterns are provided on the back surface 200B of the printed circuit board 200 opposite to the mounting surface 200A in addition to the above-mentioned wiring patterns 236B, 238B, 246B, 264, and 266. FIG. 10 is a perspective view through the mounting surface 200A shown in FIG. 9. For example, the right end of the mounting surface 200A shown in FIG. 9 is opposite to the right end of the back surface 200B shown in FIG. 10. In FIGS. 9 and 10, a double circle indicates a through-hole. The power supply patterns shown in FIG. 10 are connected to power supply patterns on the mounting surface 200A shown in FIG. 9. The power supply patterns shown in FIG. 10 are insulated on the back surface 200B excluding connection areas in areas 300 and 302 described later.

A power ground power supply pattern PGND connected to the first and second power transmission drivers, and an analog ground power supply pattern AGND and a digital ground power supply pattern DGND connected to power supply terminals of the control IC are provided as ground (GND) power supply patterns.

The analog ground power supply pattern AGND is formed in the shape of an island in a center area opposite to at least part of the control IC 100 and the waveform detection wiring patterns (narrow patterns) 250 and 252. The power ground power supply pattern PGND is formed in a first area A1 opposite to the first and second row positions P1 and P2, and a digital ground power supply pattern DGND1 is formed in a second area A2 opposite to the power ground power supply pattern PGND through the analog ground power supply pattern AGND. The digital ground power supply pattern DVSS is connected to a ground terminal 310 of the printed circuit board 200, and is connected to a ground potential through the ground terminal 310.

The power ground power supply pattern PGND and the digital ground power supply pattern DGND1 are connected in an area 300 between the island-like analog ground power supply pattern AGND and the edge of the printed circuit board 200. A digital ground power supply pattern DGND2 is formed in an area opposite to the area 300 through the analog ground power supply pattern AGND. The digital ground power supply pattern DGND2 is provided to supply a ground voltage to the terminal (pin number 32) provided on the first side SD1 of the control IC 100. The digital ground power supply patterns DGND1 and DGND2 are connected in an area 302 shown in FIG. 9.

A power power supply pattern PVDD connected to the first and second power transmission drivers DR1 and the DR2 is provided as a power supply pattern that supplies a VDD potential. The power power supply pattern PVDD is provided from the second area A2 (area of the digital ground power supply pattern DVSS) to the first area A1 (area of the power ground power supply pattern PVSS) while avoiding an area opposite to the voltage detection patterns (narrow patterns) 250 and 252 formed on the mounting surface 200A shown in FIG. 9.

One end of the power power supply pattern PVDD is provided in the second area A2 because a power supply regulator (not shown) is disposed in the second area A2. The power power supply pattern PVDD is disposed across the first area A1 because the power power supply pattern PVDD supplies a power power supply potential to the first and second transmission drivers DR1 and DR2 on the mounting surface 200A via through-holes (see FIG. 7).

The power ground power supply pattern PVSS and the digital ground power supply potential DVSS are connected only in the area 300 shown in FIG. 10. Therefore, a ground current flows through the power power supply pattern PVDD and the power ground power supply pattern PVSS into the digital ground power supply pattern DVSS through a path indicated by an arrow A in FIG. 10. Since the current path A avoids an area opposite to the voltage detection patterns (narrow patterns) 250 and 252 formed on the mounting surface 200A shown in FIG. 9, a situation in which the waveform detection signal PHIN that flows through the narrow patterns 250 and 252 is adversely affected can be reduced.

As shown in FIG. 8, the oscillator 206 provided on the mounting surface 200A of the printed circuit board 200 is provided in an area opposite to the boundary area between the island-like analog ground power supply pattern AVSS and the power ground power supply pattern PVSS shown in FIG. 10. In order to connect the oscillator 206 provided at such a position to the digital ground power supply pattern DVSS, the digital ground power supply pattern DVSS has a first protrusion pattern 312 that protrudes from the second area A2 (main area of the digital ground power supply pattern DVSS) to the first area A1 (area of the power ground power supply pattern PVSS) in the shape of a strip.

Therefore, a ground current from the oscillator 206 flows through a path indicated by an arrow B in FIG. 10. The path B is adjacent to the ground current path A of the first and second transmission drivers DR1 and DR2. Since the reference clock signal generated by the oscillator 206 is synchronized with a current that flows through the first and second transmission drivers DR1 and DR2, an adverse effect occurs to only a small extent.

The digital ground power supply pattern DVSS also has a second protrusion pattern 314 that protrudes from the second area A2 (main area of the digital ground power supply pattern DVSS) to the first area A1 (area of the power ground power supply pattern PVSS) at a position opposite to the first protrusion pattern 312 through the analog ground power supply pattern AVSS. The free end of the second protrusion pattern 314 and the free end of the first protrusion pattern 312 are closely positioned, but are not directly connected.

The analog ground power supply pattern AVSS is thus enclosed by the digital GND pattern DVSS1 and the first and second protrusion patterns 312 and 314. The power ground power supply pattern PVSS and the analog ground power supply pattern AVSS are separated in this manner.

As shown in FIG. 6, the first and second predrivers PR1 and PR2 of the control IC 100 that generates the driver control signals DP1, DN1, DP2, and DN2 supplied to the first and second transmission drivers DR1 and DR2 are formed using the complementary transistors (TP1 and TN1), (TP2 and TN2), (TP3 and TN3), and (TP4 and TN4). It is necessary to selectively supply a digital ground potential to the gates of these complementary transistors.

In order to supply the digital ground potential to the gates of the complementary transistors (TP1 and TN1) and (TP2 and TN2) that drive the first transmission driver DR1, the digital ground power supply pattern 316 (see FIG. 9) connected to the digital ground power supply pattern DVSS via a through-hole is connected to the terminal (pin number 32) provided on the first side of the control IC 100.

In order to supply the digital ground potential to the gates of the complementary transistors (TP3 and TN3) and (TP4 and TN4) that drive the second transmission driver DR2, the digital ground power supply pattern 318 (see FIG. 9) connected to the second protrusion pattern 314 via a through-hole is connected to the terminal (pin number 6) provided on the second side of the control IC 100. This enables the digital ground potential to be supplied to the complementary transistors that drive the second transmission driver DR2.

A ground current is supplied to the complementary transistors through paths indicated by arrows C and D in FIG. 10. The paths C and D are separated from the paths A and B.

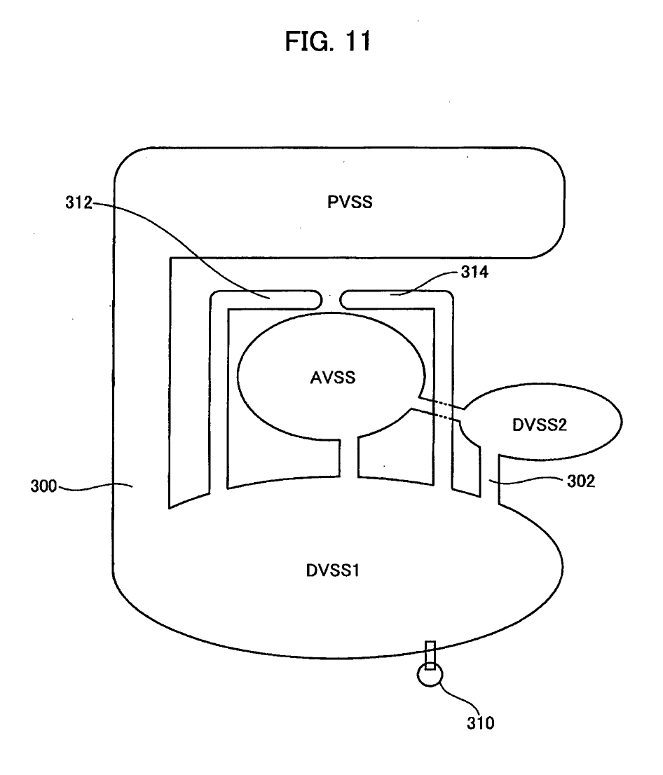

FIG. 11 schematically shows the relationship between the ground power supply patterns on the front and back surfaces of the printed circuit board 200. Although the ground power supply patterns are short-circuited, each ground potential is stabilized due to the pattern shape. The digital ground power supply pattern DVSS1 and DVSS2 can be short-circuited in potential, as shown in FIG. 11, through the analog ground power supply pattern AVSS (not shown in FIGS. 9 and 10).

The digital ground power supply pattern DVSS shown in FIG. 10 is connected to the digital ground power supply pattern 320 on the mounting surface 200A shown in FIG. 9 via a through-hole. A pattern 322 is connected to the terminal (pin number 28) provided on the fourth side SD4 of the control IC.

The analog ground power supply pattern AVSS shown in FIG. 10 is connected to the analog ground power supply patterns 322, 324, and 326 on the mounting surface 200A shown in FIG. 9 via through-holes. The pattern 322 is connected to the terminals (pin numbers 16 and 19) provided on the third side SD3 and the fourth side SD4 of the control IC.

In FIG. 10, a digital power supply pattern DVDD and an analog power supply pattern ADVV are formed as power supply patterns that supply a VDD potential. One end of the digital power supply pattern DVDD is connected to the power supply regulator through a digital power supply pattern 330 on the mounting surface 200A shown in FIG. 9 connected to a through-hole. The other end of the digital power supply pattern DVDD is connected to the terminals (pin numbers 15 and 26) provided on the first side SD1 and the third side SD3 of the control IC 100 through a digital power supply pattern 332 on the mounting surface 200A shown in FIG. 9 connected to a through-hole.

One end of the analog power supply pattern AVDD is connected to the power supply regulator in the same manner as described above. The other end of the analog power supply pattern AVDD is connected to the terminals (pin numbers 2 and 29) provided on the first side SD1 and the second side SD2 of the control IC 100 through digital power supply patterns 334 and 336 on the mounting surface 200A shown in FIG. 9.

The wiring patterns 264 and 266 shown in FIG. 10 are wiring patterns for the first thermistor RT1. The first thermistor RT1 connected to the upper ends of the wiring patterns 264 and 266 in FIG. 10 is disposed in an area opposite to the power ground power supply pattern PVSS. The power ground power supply pattern PVSS is also provided on the back surface corresponding to the first and second resonant capacitors C1 and C2. Therefore, the first thermistor RT1 and the first and second resonant capacitors C1 and C2 can be thermally coupled through the power ground power supply pattern PVSS. This improves the temperature measurement accuracy of the first thermistor RT1 with respect to the first and second resonant capacitors C1 and C2.

Although the embodiments of the invention have been described in detail above, those skilled in the art would readily appreciate that many modifications are possible in the embodiments without materially departing from the novel teachings and advantages of the invention. Accordingly, such modifications are intended to be included within the scope of the invention. Any term cited with a different term having a broader meaning or the same meaning at least once in the specification and the drawings can be replaced by the different term in any place in the specification and the drawings. The invention also includes any combination of the embodiments and the modifications.

What is claimed is:

1. A power transmission device that includes a primary coil and electromagnetically couples the primary coil with a secondary coil of a power reception device to supply power to a load of the power reception device, the power transmission device comprising:
a first coil connection terminal and a second coil connection terminal respectively connected to ends of the primary coil;
a resonant capacitor that forms a series resonant circuit with the primary coil;
a first power transmission driver and a second power transmission driver that drive the primary coil from the ends of the primary coil through the first coil connection terminal and the second coil connection terminal; and
a control IC that outputs driver control signals to the first power transmission driver and the second power transmission driver,
the first coil connection terminal, the second coil connection terminal, the resonant capacitor, the first power transmission driver, the second power transmission driver, and the control IC being provided on a mounting surface of a printed circuit board,
the control IC being formed in the shape of a quadrangle that has a first side, a second side, a third side, and a fourth side, an output terminal of the driver control signal output to the first transmission driver being provided on the first side, an output terminal of the driver control signal output to the second transmission driver being provided on the second side adjacent to the first side, an input terminal that receives a signal waveform at the second coil connection terminal through a waveform detection wiring pattern being disposed on the third side opposite to the first side, and the control IC being disposed at a position shifted in a first direction with respect to a centerline that divides the printed circuit board in two and is parallel to the first side and the third side;
the first coil connection terminal and the second coil connection terminal being disposed in a first row position on an end of the printed circuit board, and, when a direction opposite to the first direction is referred to as a second direction, the second coil connection terminal being disposed at a position shifted in the second direction with respect to the centerline;
the resonant capacitor being disposed in a second row position between the first row position where the first coil connection terminal and the second coil connection terminal are disposed and a row position where the control IC is disposed;
the first power transmission driver and the second power transmission driver being disposed between the first row position and the row position where the control IC is disposed, and the first transmission driver being disposed at a position shifted in the first direction with respect to the first side of the control IC; and
the waveform detection wiring pattern extending from the third side of the control IC to the second coil connection terminal through an area of the printed circuit board shifted in the second direction with respect to the centerline.

2. The power transmission device as defined in claim 1,
the resonant capacitor including a first resonant capacitor connected to the first coil connection terminal and a second resonant capacitor connected to the second coil connection terminal;
the second power transmission driver being disposed between the first resonant capacitor and the second resonant capacitor disposed in the second row position;
the first transmission driver being disposed in a third row position adjacent to the second row position; and
the control IC being disposed in a fourth row position adjacent to the third row position.

3. The power transmission device as defined in claim 1,
the waveform detection wiring pattern including a wide pattern formed from the second coil connection terminal to a position shifted in the second direction with respect to the second coil connection terminal in the second row position, and a narrow pattern, one end of the narrow pattern being connected to the wide pattern and the other end of the narrow pattern being connected to the input terminal provided on the third side of the control IC.

4. The power transmission device as defined in claim 3,
the power transmission device including power supply patterns provided on a back surface of the printed circuit board opposite to the mounting surface,
the power supply patterns including:
a power ground power supply pattern connected to the first power transmission driver and the second power transmission driver; and
an analog ground power supply pattern and a digital ground power supply pattern connected to power supply terminals of the control IC;
the analog ground power supply pattern being formed in the shape of an island in a center area opposite to at least part of the control IC and the narrow pattern of the waveform detection wiring pattern, the power ground power supply pattern being formed in a first area opposite to the first row position and the second row position, and the digital ground power supply pattern being formed in a second area opposite to the power ground power supply pattern through the analog ground power supply pattern; and
the power ground power supply pattern and the digital ground power supply pattern being connected in an area between the analog ground power supply pattern in the shape of an island and an edge of the printed circuit board.

5. The power transmission device as defined in claim 4,
the power supply patterns further including a power power supply pattern connected to the first power transmission driver and the second power transmission driver; and
the power power supply pattern being provided from the first area to the second area while avoiding an area opposite to the narrow pattern of the waveform detection wiring pattern formed on the mounting surface.

6. The power transmission device as defined in claim 4,
the power transmission device including an oscillator that is provided on the mounting surface of the printed circuit board and is connected to a terminal provided on the second side of the control IC, the oscillator being disposed at a position opposite to a boundary area between the analog ground power supply pattern and the power ground power supply pattern provided on the back surface of the printed circuit board,
the digital ground power supply pattern including a first protrusion pattern that protrudes from the first area to the second area in the shape of a strip so that the digital ground power supply pattern is connected to the oscillator.

7. The power transmission device as defined in claim 6,
the oscillator being provided on the mounting surface of the printed circuit board between a wiring pattern that connects the second transmission driver with a terminal provided on the second side of the control IC and the waveform detection wiring pattern.

8. The power transmission device as defined in claim 6,
the digital ground power supply pattern further including a second protrusion pattern that protrudes from the first area to the second area in the shape of a strip, the second protrusion pattern being provided at a position opposite to the first protrusion pattern through the analog ground power supply pattern; and
the analog ground power supply pattern being enclosed by the digital ground power supply pattern, the first protrusion pattern, and the second protrusion pattern.

9. The power transmission device as defined in claim 8,
the control IC including a first predriver and a second predriver that generate the driver control signals supplied to the first power transmission driver and the second power transmission driver, each of the first predriver and the second predriver including complementary transistors; and
the second protrusion pattern being set at a ground potential supplied to gates of the complementary transistors.

10. The power transmission device as defined in claim 4,
the power transmission device including a first thermistor that detects a temperature of the resonant capacitor, the first thermistor being disposed on the mounting surface of the printed circuit board between the second row position and the row position where the control IC is disposed.

11. The power transmission device as defined in claim 10,
a terminal that is connected to the first thermistor being disposed on the fourth side of the control IC; and
the first thermistor and the terminal disposed on the fourth side being connected on the back surface of the printed circuit board through a wiring pattern provided between the analog ground power supply pattern in the shape of an island and the digital ground power supply pattern.

12. The power transmission device as defined in claim 10,
the first thermistor being thermally coupled with the resonant capacitor through the power ground power supply pattern.

13. The power transmission device as defined in claim 10,
the power transmission device including a second thermistor that detects an ambient temperature, the second thermistor being disposed on the mounting surface of the printed circuit board at a position opposite to the fourth side of the control IC,
the second thermistor and a terminal provided on the fourth side of the control IC being connected through a wiring pattern.

14. The power transmission device as defined in claim 13,
the control IC including a temperature detection circuit that detects an abnormality in tan δ of the resonant capacitor by calculating a difference between the temperature of the resonant capacitor from the first thermistor and the ambient temperature from the second thermistor.

15. The power transmission device as defined in claim 14,
the control IC including a control circuit that stops power transmission using the first power transmission driver and the second power transmission driver when an abnormality in tan δ of the resonant capacitor has been detected.

16. An electronic instrument comprising the power transmission device as defined in claim 1.

17. A power transmission device that supplies power to a power reception device, comprising:
a primary coil that couples with a secondary coil of the power reception device electromagnetically;
a first coil connection terminal and a second coil connection terminal respectively connected to ends of the primary coil;
a resonant capacitor that forms a series resonant circuit with the primary coil;
a first power transmission driver and a second power transmission driver that drive the primary coil, the first power transmission driver electrically connected to the first coil connection terminal, the second power transmission driver electrically connected to the second coil connection terminal; and
a control IC that outputs driver control signals to the first power transmission driver and the second power transmission driver,
the first coil connection terminal, the second coil connection terminal, the resonant capacitor, the first power transmission driver, and the control IC being provided on a circuit board,
the control IC having a first side, a second side, a third side, and a fourth side, an output terminal of a first driver control signal to the first transmission driver being provided beside of the first side, an output terminal of a second driver control signal to the second transmission driver being provided beside of the second side, the second side crossing the first side, an input terminal that receives a signal of the second coil connection terminal via a waveform detection wiring pattern being disposed beside of the third side, the third side oppositing to the first side, and the control IC being disposed on a first area of the circuit board, the first area being an area of first direction side from a centerline, the centerline divides the circuit board in two and is parallel to the first side,
the first coil connection terminal and the second coil connection terminal being disposed in a first row position beside of one side of the circuit board, and the second coil connection terminal being disposed on a second area of the circuit board, the second area being an area of second direction side from the centerline, the second direction side being a opposite side to the first direction side,
the resonant capacitor being disposed an a second row position between the first row position and a row position where the control IC is disposed,
the first power transmission driver and the second power transmission driver being disposed between the first row position and the row position where the control IC is disposed, and the first transmission driver being disposed at a position of the first direction side from the first side of the control IC,
the waveform detection wiring pattern extending from the third side of the control IC to the second coil connection terminal through the second area.

18. An electronic instrument comprising the power transmission device as defined in claim 17.
